(19) United States
(12) Patent Application Publication
(10) Pub. No.: US 2013/0138525 A1
(43) Pub. Date: May 30, 2013

(54) System for Mobile Electronic Commerce

(71) Applicant: JAMES BERCAW, Playa Del Rey, CA (US)

(72) Inventor: JAMES BERCAW, Playa Del Rey, CA (US)

(21) Appl. No.: 13/749,549

(22) Filed: Jan. 24, 2013

Related U.S. Application Data
(62) Division of application No. 12/932,997, filed on Mar. 11, 2011.

(51) Int. Cl. G06Q 30/06

(52) U.S. Cl. CPC G06Q 30/0601
USPC 705/26.1

(57) ABSTRACT

A System for Mobile Electronic Commerce includes a first server, a first database, and a mobile application executable on a mobile device. The first server is in communication with a first database. The first database stores bar code information.

### CROSS-REFERENCE

The present Patent Application is hereby cross-referenced to the Patent Application entitled “A System for Marketing and Advertising through Mobile Electronic Commerce”.

### FIELD OF THE INVENTION

The present invention is in the area of mobile commerce, and more particularly pertains to systems and methods to facilitate the purchase of products with mobile handsets.

### BACKGROUND OF THE INVENTION

Cellphones, Smartphones, or other handsets have recently transitioned from being perceived to be luxury or gadget items to indispensable appliances which are critical to the day-to-day functions of society. In point of fact, in some urban areas, cellphones are replacing landlines altogether. The number of US households exclusively using cellphones and eschewing the use of landlines is growing rapidly. In 2008, worldwide mobile subscriptions surpassed 4 billion.

The reasons for this trend is manifold. Most cellphones or smartphones are now packaged with more computing processing power and hard drive space than many desktop computers were equipped with just a couple decades ago. What's more is the fact that many smartphones are enabled for internet access. This ubiquitous internet access has untethered many people from their desktop computers to free them up to work from the field, or to work from home. This freedom enables many people to monitor their emails, communicate with co-workers, friends and relatives from virtually anywhere they go. In addition, many users are availing themselves of the ability to purchase various products and services online through their smartphones.

Tracking alongside the explosion of use of smartphones is online commerce. The growth of online sales has multiplied in recent years and has solidified its inexorable standing in e-commerce. Not surprisingly, online retailers have not only noticed increased sales originating from desktop computers, but have also noticed strong growth in mobile internet commerce.

Many factors inhere with the positive growth of mobile internet commerce such as the rapid technological advances in smartphones. In particular, many smartphones are equipped with excellent cameras, processing power, and functionalities regarding internet connections, and software applications.

For instance, many cellphones now have the ability to take pictures of bar codes, and process the information therein to read various information. This feature, amongst others have heretofore been untapped in terms of its potential to accelerate the use of mobile commerce.

Moreover, many other opportunities for upselling, suggestive selling, promotional text messages, etc. have not been fully monetized through a coherent system which links users, merchants, and registries of enrolled merchants to directly target consumers in real time who are in the process of purchasing various classes of goods or services. Instead, currently most credit card, or debit card services provided little ancillary value in exchange for their standard transaction fees.

Therefore, what is clearly needed in the art is a system, and attendant methods for enabling enhanced mobile commerce. Such a method and system should provide value added financial transactions which enable merchants, and registered advertisers to increase sales through direct promotional materials to a user's smartphone via an installed mobile application.

### SUMMARY OF THE INVENTION

It is an object of the present invention to provide a system and apparatus to enable a customer to initiate a transaction by taking an image of a bar code with their smartphone. The system will provide for a mobile application which enables for the encoding and decoding of the bar code information.

It is an object of the present invention to provide for an enrolled registry of advertisers to directly promote, upsell, cross-sell, suggestive-sell their products or services which may be in line, part and parcel, or attendant to a transaction for a good or service which a customer is consummating in real time. This system can also be implemented to enhance a user's purchasing experience by building brand loyalty, and also from gaining insight into their particular buying behavior for future use.

It is an object of the present invention to provide a system, and attendant business methods for accelerating a purchase of a product or service by a user at a merchant's brick and mortar location. This service can alleviate long lines at a retail outlet, and possibly easing the burden or load placed on sales staff.

### BRIEF DESCRIPTION OF THE DRAWING FIGURES

FIG. 1 is a block diagram of a preferred embodiment of the present invention.

FIG. 2 is a block diagram of a preferred embodiment of the present invention.

FIG. 3 is a block diagram of a preferred embodiment of the present invention.

FIG. 4 is a block diagram of a preferred embodiment of the present invention.

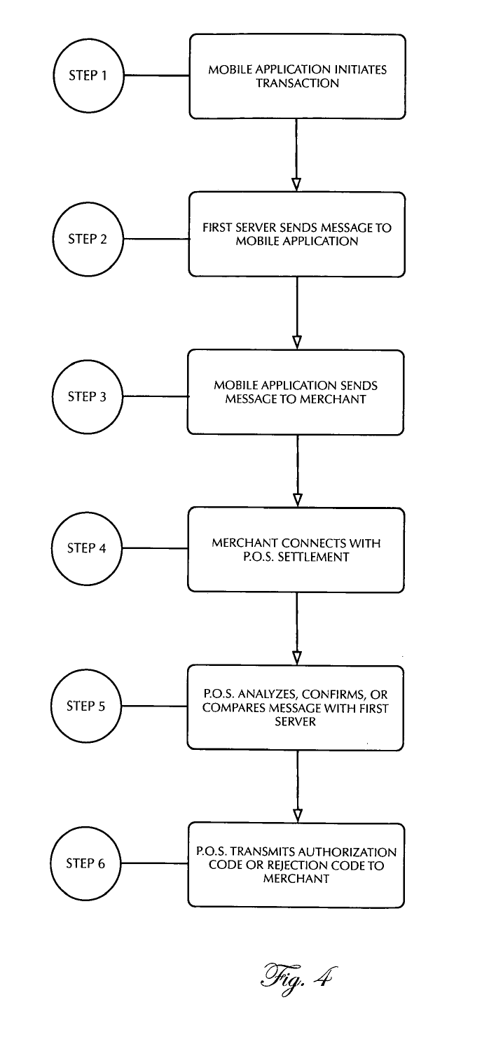

### DESCRIPTION OF PREFERRED EMBODIMENTS

According to a preferred embodiment of the present invention, a unique System for Mobile Electronic Commerce 100 allows for easier transactions between consumers and merchants. Furthermore, the System for Mobile Electronic Commerce 100 enables a variegated set of options for merchants to advertise their goods and services to potential consumers. Moreover, the present invention can be implemented to build brand loyalty, strengthen merchant-consumer goodwill, and increase up-sells. The present invention is described in enabling detail below.

For the purposes of the present invention, the terms “handset”, “smartphone”, cell phone, or other device are interchangeable. These devices should be able to execute a mobile application, send and receive short message service (hereafter “SMS”) text messages, establish an Internet connection, capture and display images with an integrated module (camera), and store memory.

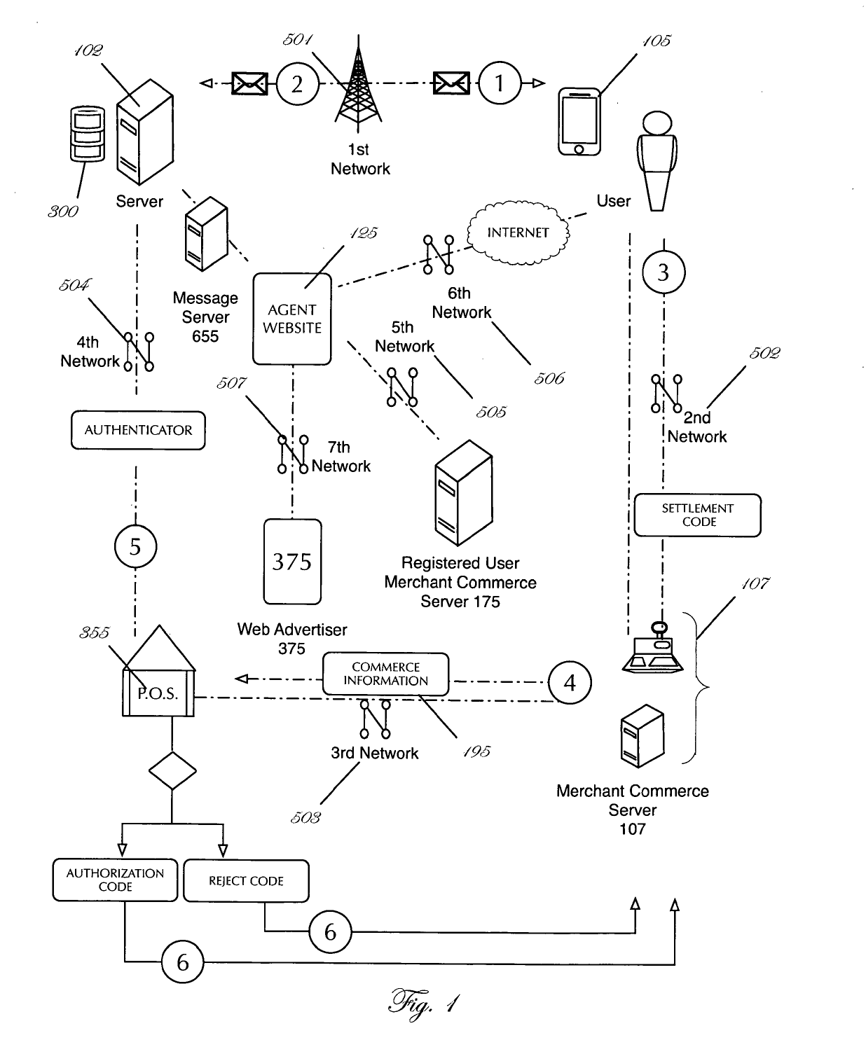

FIG. 1 illustrates a preferred embodiment of the present invention. In some preferred embodiments the System for Mobile Electronic Commerce 100 includes a first server 102, a first database 300, and a mobile application 205 executable on a mobile device 105. The first server is in communication with a first database. The first database stores bar code information.

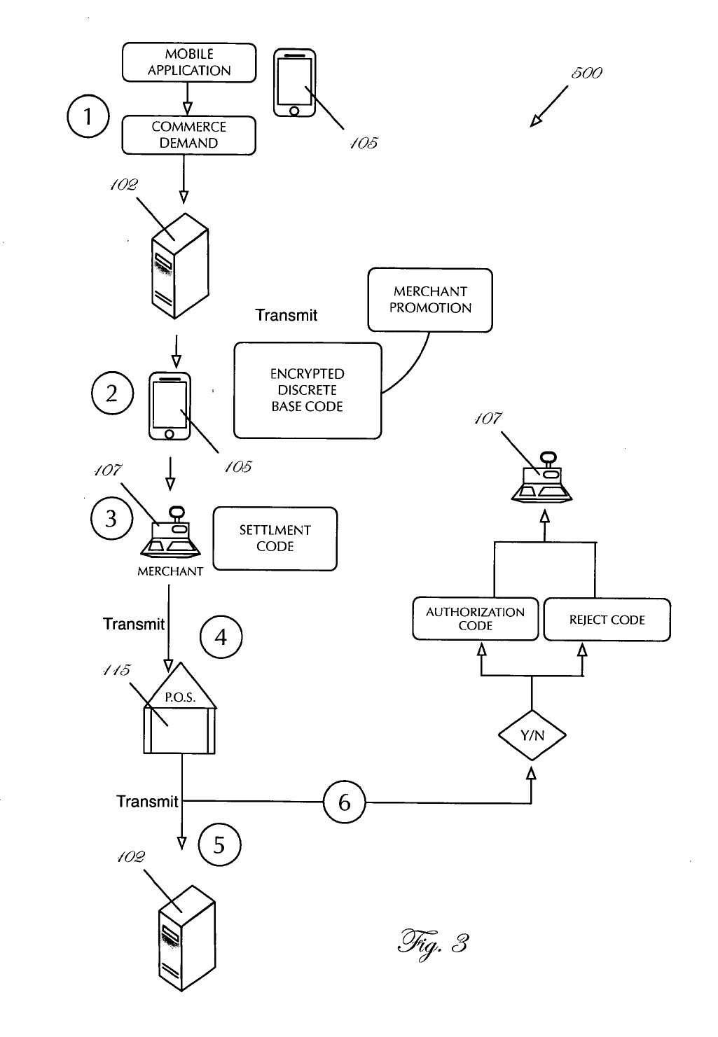

FIG. 3 illustrates a flow diagram of a method to be incorporated into the present invention. A Method for Mobile Electronic Commerce 500 is comprised of the steps of receiving (Step 1) a commerce initiation message from a mobile application to a first server. By way of example, if a customer wishes to purchase a product or a service, user may open the mobile application on their smartphone or handset. And after navigating through a plurality of options, user may proceed to complete the transaction. Subsequently, the mobile application may send the commerce initiation message to the first server through the cell network 120.

This commerce initiation message may comprise account identification information, counterparty identification information, passwords, etc. Most of this information may be pre-defined or predetermined when a user first activates, registers, or enrolls which is attendant to the activation procedures of the mobile application upon the user's smart phone. Moreover, parts of the initiation message may be extracted from the decoding of a bar code image.

Alternatively, the mobile application may disseminate the commerce initiation message through the internet (via an ISP, or Internet Service Provider) to the first website using an agent website as the conduit through which the commerce initiation message is channeled.

It should be noted, that in some preferred embodiments, this first step may be automatically actuated, or provisionally actuated by a simple scanning of a bar code through the user's hand set. This bar code may be disposed upon an item, or placard or electronic terminal display found at a brick and mortar location.

The mobile application is enabled to either encode or decode a bar code. As such, the smart phone upon which the mobile application operates further includes a digital capture, or camera module.

The mobile application may be able to read and write one dimensional bar codes 201 where lines are aligned along a single axis. And in some preferred embodiments, the mobile application may be enabled to read and write two or three dimensional bar codes 202 as well. This bar code can indicate a pathway to the first server, and also query various information from the first server on how to consummate a transaction between the mobile application and the first server.

In some preferred embodiments, the transaction initiating information in Step 1 includes an account identification information corresponding to the account record, a password to access the account, identification of the second party in the transaction corresponding to the second party of a cash settlement in the transaction, a temporary decryption password key associated with a discrete base code. This temporary password key is used for the purposes of security over the SMS network.

Step 2 includes sending a second message from the first server to the mobile application. This message may comprise a base code (which acts as the authorization information) and/or promotional information. This message may be delivered via wireless transmission, typically at a radio frequency from a base station. This message may be conducted through a wireless gateway 120.

The message sent may be an encrypted discrete base code. In some preferred embodiments, this encrypted discrete base code may be disseminated to the mobile application through an SMS message. This message may also be referred to as the instructions. In addition, a promotion from an advertiser may also accompany the encrypted discrete base code to the mobile application.

This promotional message may include suggestive selling messages, coupons, sales information, and other indicia used for the purpose of building brand awareness and loyalty. Messages may be in the form of text, images, video, and other multimedia.

The account record represents a sum of cash that can be spent by the first user in the transaction. In some preferred embodiments, the authorization information may incorporate a discrete base code, instructions for generating a settlement code signal to the second party, confirmation of the second party.

Step 3 includes sending a third message from the mobile application to a second party. Typically, this second party is the merchant 107, and is the intended recipient of cash. This third message is essentially the discrete base code previously sent to the mobile application from the first server and modified by the mobile application.

In some preferred embodiments, the mobile application is enabled to generate a settlement code by encoding alphanumerical data and instructions into a bar code. In some preferred embodiments, the mobile application may be able to encode a bar code from data and instructions received from the first server. Attendant to this process is the input of the user's password into the mobile application to be verified by the first server. Other safety features may be required such as the user's social security number, zip code, answers to security questions, or other predefined counter-fraud measures and protocols.

This settlement code may include the input of transaction information such as invoice code, terminal identification, settlement amount, and other typical information which is associated with purchases.

In some preferred embodiments, this step can be automatically sent to the second party from the mobile application. Alternatively, a user may simply show the SMS message to the second party, or merchant for verification.

In operation, a user may simply show a merchant (at a brick and mortar location) the settlement code found on their smartphone through the mobile application. The merchant can either scan the bar code and attendant information. Alternatively, the merchant may be able to manually input the indicia found in the SMS.

The settlement code, or payment code is configured to be in compliance with various industry standard signals such as ISO IEC 15693 for RFID signal or PDF 417 or Code 128 for a bar code in some preferred embodiments. This configuration may be executed through use of a compliant terminal to be used by the merchant which is communicatively coupled through an Internet, or similar connection.

In Step 4, with some preferred embodiments, the merchant will have to connect with a clearing house, or other P.O.S. 355 Settlement Interlink to verify, confirm, approve, reject, etc. the discrete base code passed from the first server to the mobile application. The P.O.S. Settlement Interlink, or third party is in communication with the first server by way of the fourth network.

In some preferred embodiments, the settlement code is comprised of a multi-digit sequence of alphanumeric characters derived from the decrypted discrete base code. In turn, the settlement code may be further comprised of either a multi-digit user-identification number (PIN. Number) or a similar security related number. The first part of the settlement code is an alphanumeric code which identifies the agent system as the payment transactor. The next part of the settlement code is a temporary, or a virtual account alphanumeric code which is exclusive, and known only by the first server and the third party (P.O.S.), base code and password, together known only by the first server and the mobile application. The final digits in a settlement code are transaction identification related and are placed by the customer/user. The third party may be responsible for reviewing and approving various transactions between the mobile application and the merchant using credit ratings, listings on OFAC (Office of Foreign Assets Control), and attendant registries.

Step 5 includes analyzing/comparing/confirming the third message from the second party through the first server through a settlement provider.

Step 6 includes transmitting either an authorization code or a reject code from the third party to the second party. Again, this message will depend upon the communication between the third party and the first server.

Once the entire transaction is consummated, in Step 6, the first server may send a notification, receipt, or other confirmation of the consummation of the transaction to the first user. This information may be stored within the mobile application as part of the history file which may be used at a later time. The notification of the settlement of the transaction corresponds to the first account record.

FIG. 1, illustrates that in some preferred embodiments, the System for Mobile Electronic Commerce 100 includes a first network 501, a second network 502, a third network 503, a fourth network 504, a fifth network 505, a sixth network 506, and a seventh network 507.

The first network is in communication with the mobile application and the first server. The first network is primarily the wireless cellular network upon which the mobile application operates. Alternatively, may be an internet connection through the user's smartphone. In this instance, the mobile application may interface with a website 125 in communication with the first server.

The second network 502 is in communication with the mobile application and the second party, or merchant. In those instances where the user/mobile application is physically located at merchant's store, the connection is not necessarily through a transmission means. Alternatively, if merchant is web-based, the connection may be by either cellular network or through the Internet.

The third network 503 is in communication with the second party (merchant) and a P.O.S. (merchant payment gateway, P.O.S., clearing house, etc). This network may be an existing message server system connected by way of a LAN to a wireless or wired infrastructure for accepting electronic payments via a Point of Sale settlement host such as Interlink™. Upon receipt of the settlement code from the mobile application, or user, this code and merchant's commerce information is then transmitted to the third party for verification purposes. As the third party communicates with the first server, the third party will either tender an authorization or a rejection code to the merchant.

The fourth network 504 is in communication with the first server and the third party. Again, this communication link enables the authorization, settlement, and/or confirmation of the authenticated code to be reconciled between the third party and the first server. The third party (settlement host) is enabled to authorize the payment on behalf of the commerce agent on a stand-alone basis, or in conjunction with an authorization from the first server.

The fifth network 505 is in communication with a registered server and a first website. This network may be internet or mobile device based. Again, this registered server is controlled and operated by a subscriber to an advertising service. Enrolled parties may enjoy direct access to prospective customers or clients by way of promotional text messages, or other promotional multimedia messages to be sent from the first server to the mobile application which is attendant with the transaction to be consummated between the mobile application and the primary merchant.

The sixth network 506 is in communication with the first website and the mobile application. This network is also internet based and is the conduit through which the mobile application and the first server communicate. This network enables the creation and maintenance of the user's account. The user's account, generated in part through the mobile application, establishes the identity, security, interests, and other user-related information. The mobile application may access transaction history via the sixth network.

The seventh network 507 is in communication with the first website and an advertiser 375. This network is incorporated for the purpose of establishing and maintaining an advertiser account. As with the user's account, the advertiser's account establishes the identity, security, and articles of commerce to be displayed on the website.

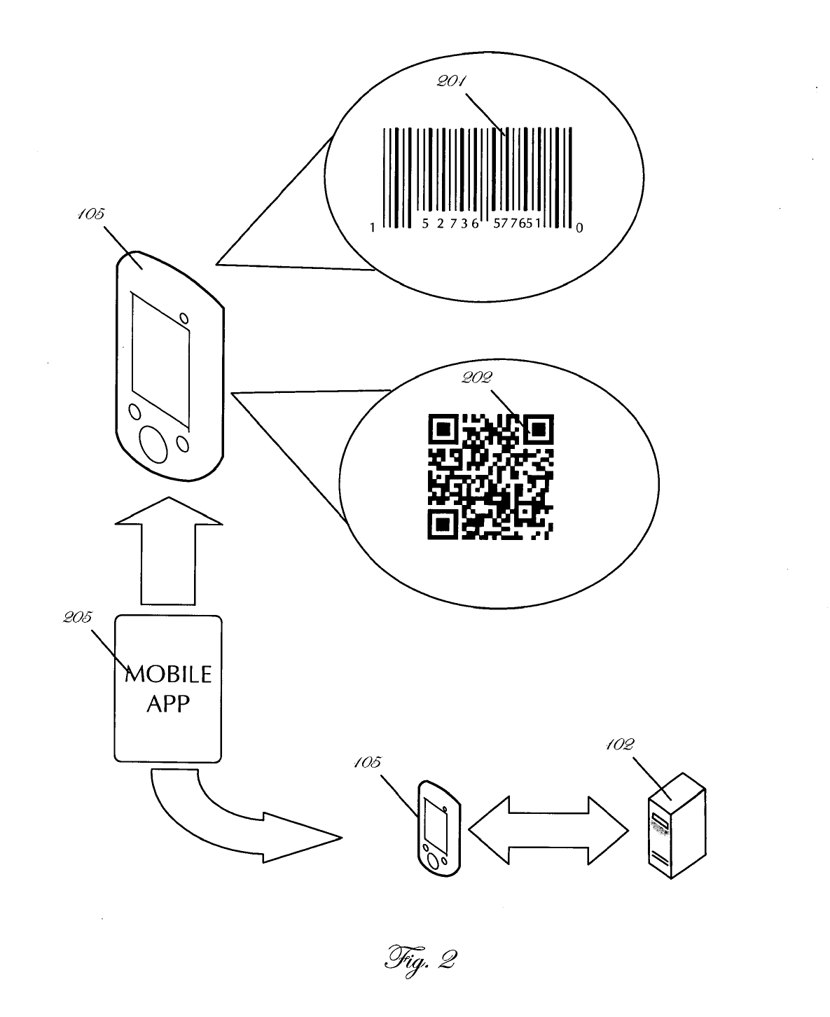

FIG. 2 illustrates that in some preferred embodiments, the mobile application is enabled to encode an alphanumeric code using standardized symbology into an image of a bar code. Moreover, in some preferred embodiments, the mobile application is enabled to decode a bar code image and translate the bar code image into constituent information therein.

In some preferred embodiments, the settlement code comprises a decrypted base code to temporarily identify the account record, wherein the discrete base code changes after each transaction. Also, in some preferred embodiments, the settlement code further comprises a modification to identify the first party and a modification to identify the transaction. Furthermore, in some preferred embodiments, the discrete base code is encrypted and decrypted based upon a first party-defined temporary password key, which changes after each subsequent transaction.

In some preferred embodiments the System for Mobile Electronic Commerce 100 may also include transaction information modification. The transaction information modification comprises identification information about a first party, a second party 107, or a third party 115, a transaction settlement amount, an invoice code, and a terminal identification.

In some preferred embodiments , the System for Mobile Electronic Commerce 100 may also include a first party information identification modification. The first party information modification may include information personally known by the user such as a user's address, password, security question information, birth date, social security numbers, or a driver's license number.

In some preferred embodiments, the settlement code and the authorization code may be operable to enable approval and funding of a transaction and may actuate a transfer of funds. In addition, the System for Mobile Electronic Commerce 100 may also utilize a settlement and authorization code processing apparatus for the purpose of authenticating a subsequent settlement code with each transaction regarding the account record.

It should be pointed out here, that in some preferred embodiments, the authorization code is terminated after a predetermined period of time. Also, the authorization code is limited to a single approved use or transaction in some preferred embodiments.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A Method for Mobile Electronic Commerce comprising:
receiving a commerce initiation message from a mobile application to a first server;
sending a second message from the first server to the mobile application;
sending a third message from the mobile application to a second party;
analyzing the third message from the second party through the first server through a third party;
transmitting either an authorization code or a reject code from the third party to the second party.

2. The Method for Mobile Electronic Commerce of claim 1 further comprising the step of encoding a bar code image with the mobile application.

3. The Method for Mobile Electronic Commerce of claim 2 further comprising the step of decoding a bar code image with the mobile application.

4. The Method for Mobile Electronic Commerce of claim 3 wherein the mobile application is capable of displaying a bar code and transmitting a signal to the second party.
